(19) United States
(12) Patent Application Publication
(10) Pub. No.: US 2010/0314216 A1
(43) Pub. Date: Dec. 16, 2010

(54) APPARATUS FOR UNSCRAMBLING AND ORIENTING PREFORMS OR OBJECTS IN GENERAL

(75) Inventor: Mario Lanfranchi, Collecchio (Parma) (IT)

Correspondence Address: YOUNG & THOMPSON, 209 Madison Street, Suite 500, Alexandria, VA, 22314, US

(73) Assignee: LANFRANCHI S.R.L., Collecchio (Parma) (IT)

(21) Appl. No.: 12/446,032

(22) PCT Filed: Jan. 23, 2007
(86) PCT No.: PCT/EP07/00532

§ 371 Date: Apr. 17, 2009

(30) Foreign Application Priority Data
Oct. 17, 2006 (IT) PR2006A000091

(51) Int. Cl. B65G 47/24

(52) U.S. Cl. 198/392

(57) ABSTRACT

An apparatus (1) for unscrambling and orienting plastic preforms (5) or any object having neck lips or collars larger than the body, the preforms or objects being introduced in bulk in a hopper (2) of such apparatus, the hopper being formed of a base (2b) and vertical walls (2c) for holding the performs. Within such hopper, an annular ring (3), rotating about an axis of rotation, has two or more rows of pockets (V) along corresponding concentric circumferences (C1, C2, . . . , Cn), and an annular object supporting surface (8), extending along an angular section under the circular ring up to the predetermined object exit point. Near the end of the support surface, bars are provided for receiving and orienting the objects from the overlying pockets (V); such bars (15) defining at least as many paths as the rows of pockets, i.e. circumferences (C1, C2, . . . Cn) of the upper ring.

The present invention relates to an apparatus for orienting and unscrambling plastic bottle preforms, also known in the art as parisons.

The present apparatus, and the protection requested therefor, extends to the use of any object adapted to be unscrambled and oriented, i.e. having neck lips or collars larger than the body, so that their proper orientation can be defined using special gripper bars.

A first prior art apparatus includes a movable inclined system having a row of pockets arranged along the periphery of the machine, each being adapted to receive one of the preforms loaded therein in bulk; by rotation of the movable system, each pocket carries the preform onto a first widened opening or slit, which is smaller than the diameter of the collar of the preform but large enough to allow the latter to rotate and take an upright position; then, the preform is moved into a second widened opening, or slit, larger than the former and than the collar diameter, so that such preform can freely slide below the movable system, where an inclined ramp is provided for guiding the fallen preform and bring it to the blow molding machine.

A second apparatus comprises a circular hopper (or container), having a ring 3 therein, concentric with such hopper and with a series of indentations adapted to create pockets or housings, which are in turn adapted to contain one preform at a time in an essentially horizontal position: the hopper is inclined so that bulk preforms lie in the bottom portion and, as they move into the housings, they are carried to an appropriate level by such housings.

The object of this invention is to provide a preform unscrambling device, which is improved particularly in terms of output.

The above object and advantages are all achieved by the unscrambling and orienting apparatus according to this invention, which is characterized by the annexed claims.

These and other features will be more apparent from the following description of a few embodiments, which are shown by way of example and without limitation in the accompanying drawings, in which:

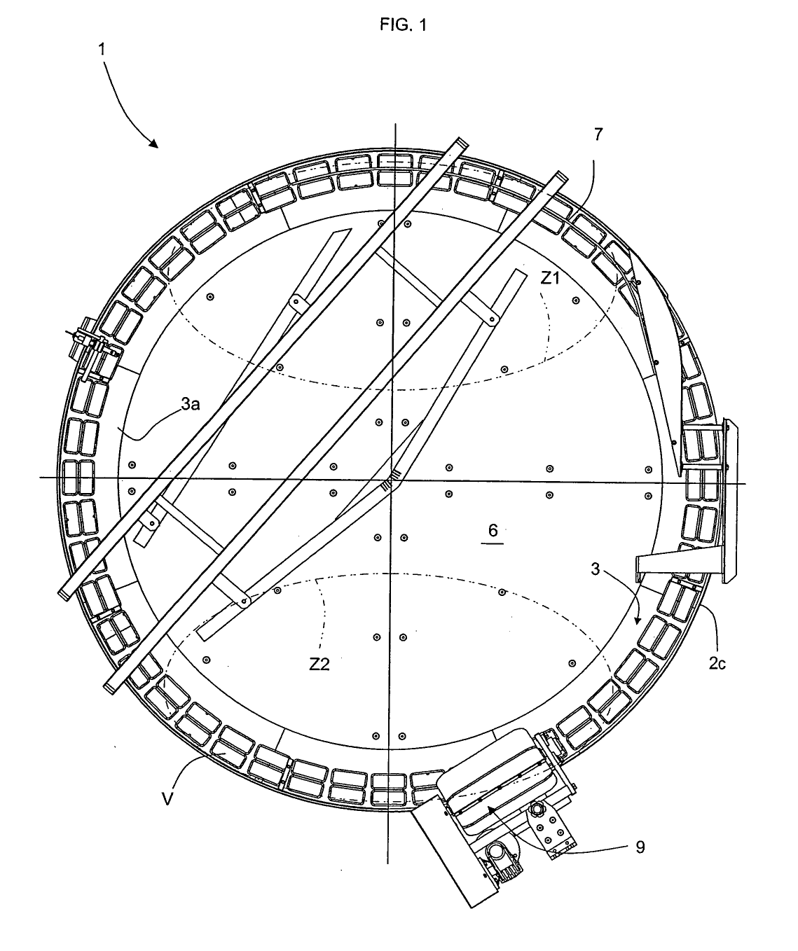

FIG. 1 is a top view of a preform unscrambling apparatus according to the present invention,

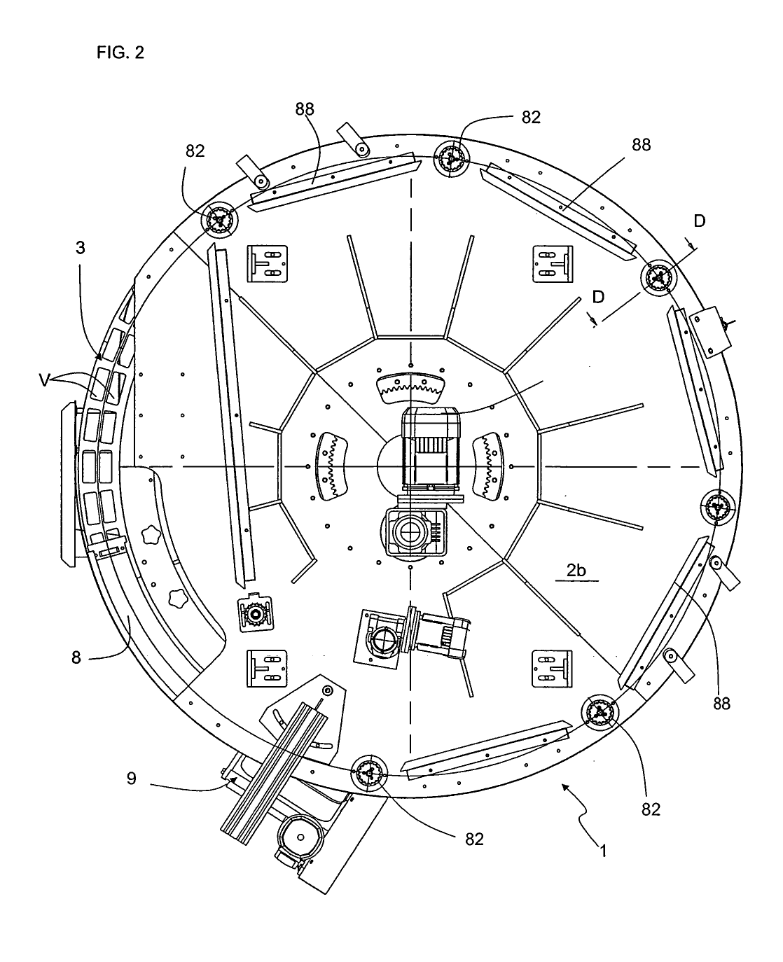

FIG. 2 is a bottom view of the unscrambling apparatus of FIG. 1,

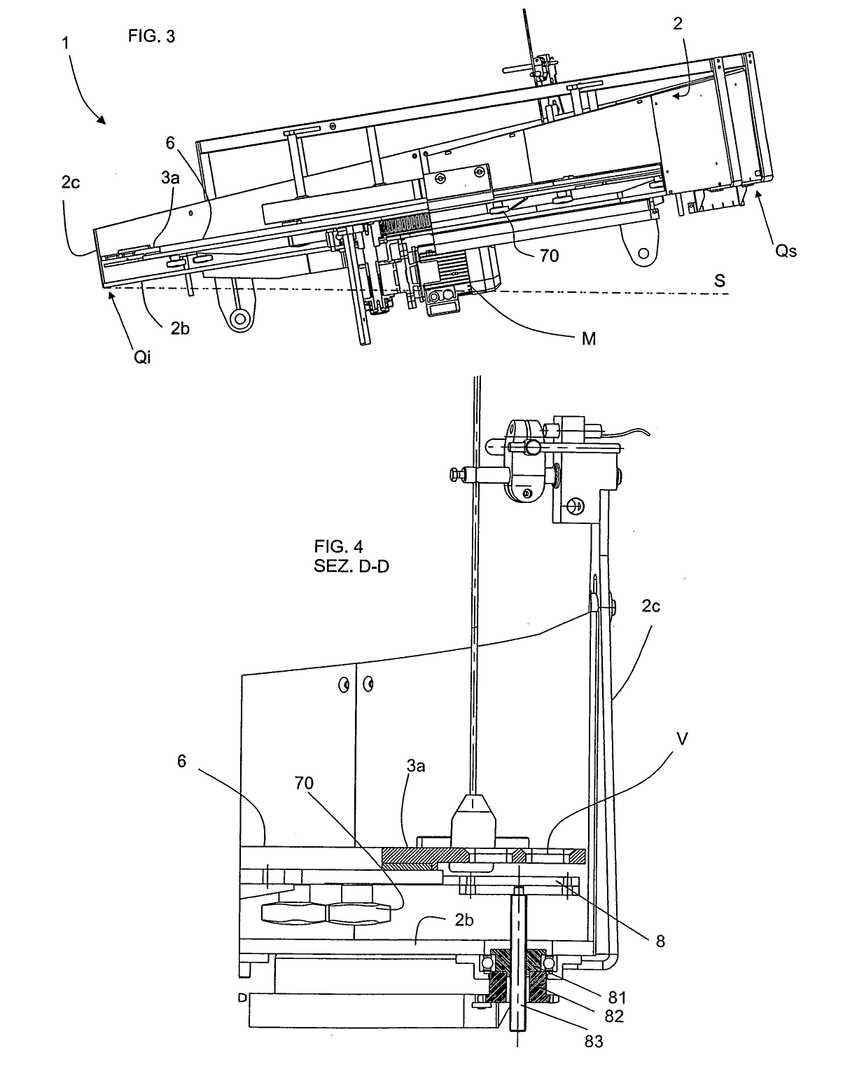

FIG. 3 is a side view of the apparatus,

FIG. 4 shows the D-D section of FIG. 2,

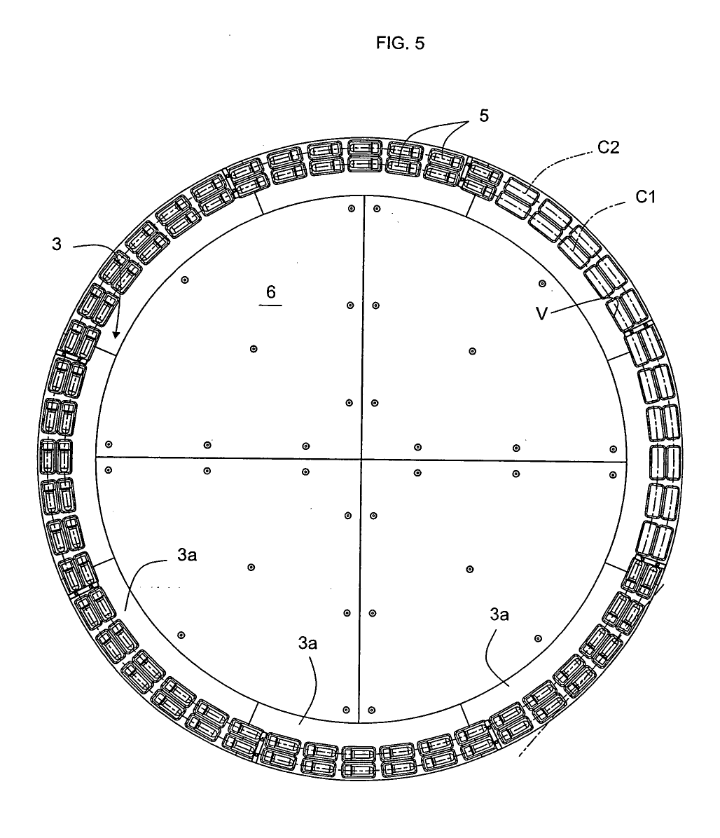

FIG. 5 is a view of the assembly composed of the circular ring and the inside plate of the present apparatus,

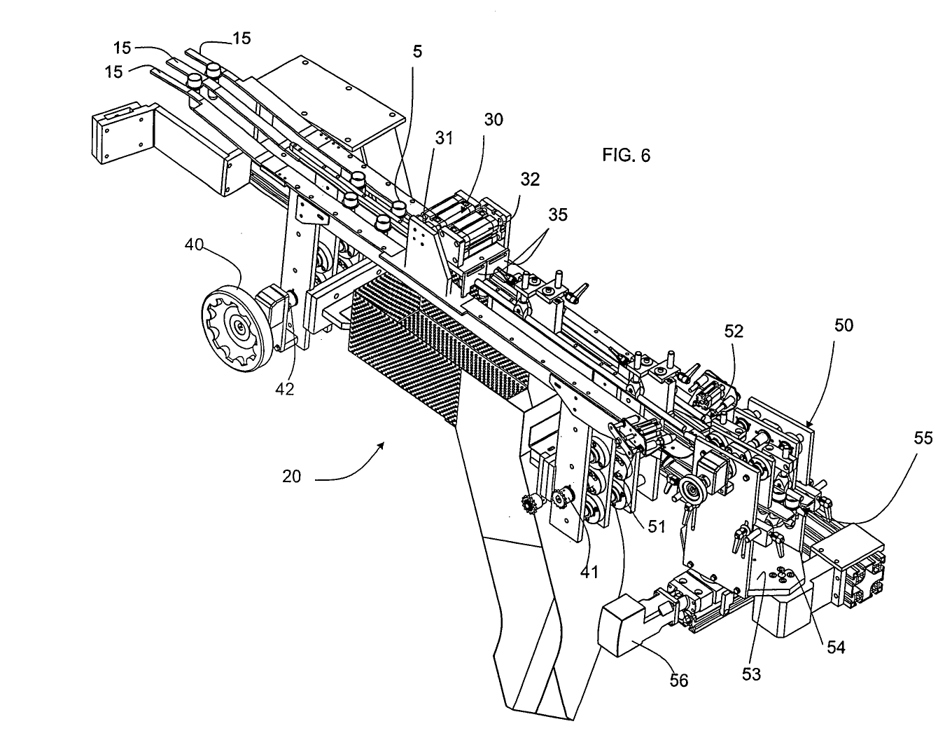

FIG. 6 is a perspective view of a device for conveying/orienting the preforms exiting from the unscrambling apparatus,

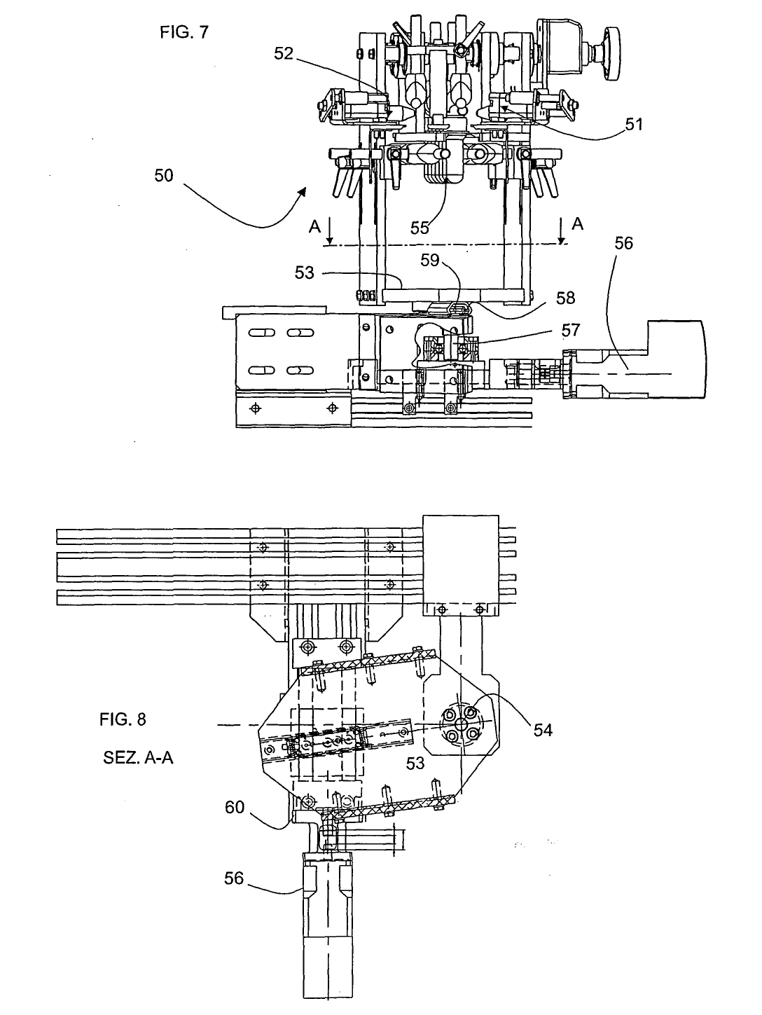

FIG. 7 is a front view of the deflector unit of the conveyor as shown in FIG. 6,

FIG. 8 shows the A-A section of FIG. 7,

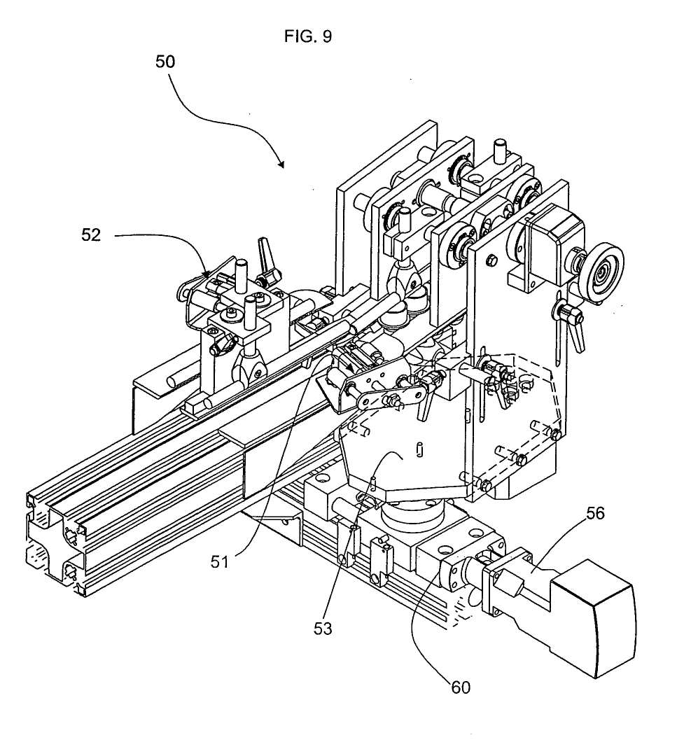

FIG. 9 is a perspective view of the device of FIG. 7,

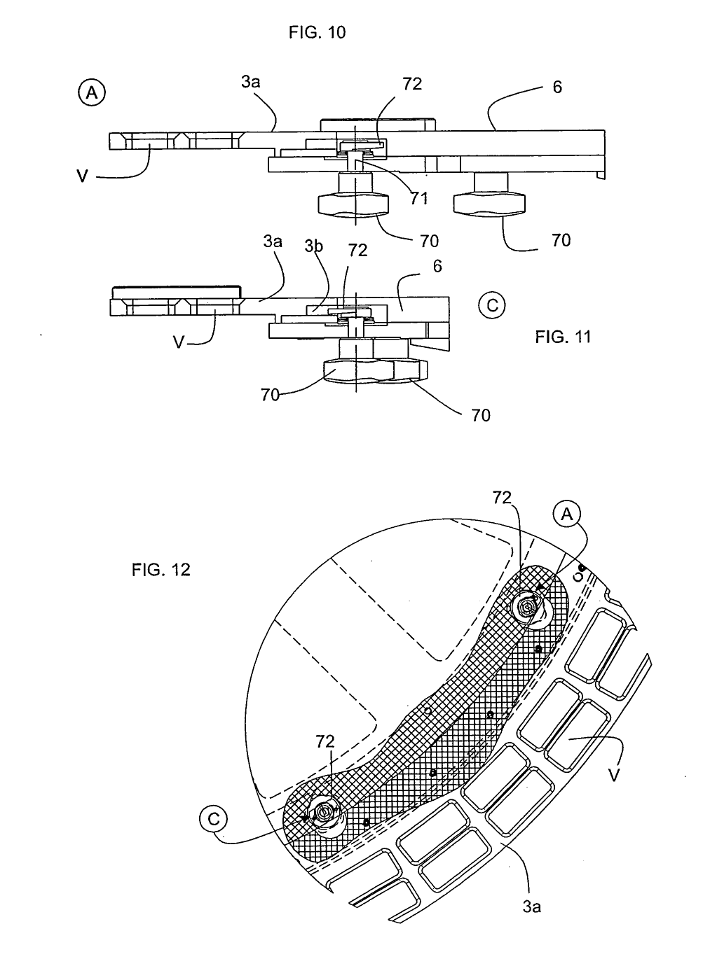

FIG. 10 shows a radial section of the assembly composed of the central plate and the circular ring, with the ring or a sector thereof separated,

FIG. 11 shows a radial section of the assembly composed of the central plate and the circular ring, with the two elements joined together.

Referring to FIGS. 1, 2, 3 and 4, numeral 1 generally designates an apparatus for unscrambling and orienting plastic preforms.

Such apparatus 1 comprises a hopper 2 within which an annular ring 3 may rotate about a central axis of rotation, having pockets V for unscrambling preforms introduced in bulk in the hopper 2.

The hopper preferably has a circular conformation, i.e. with a base 2b and a shell 2c, and the annular ring 3 is disposed in it.

Therefore, the function of the hopper 2 is to hold the preforms 5 in bulk, whereas the ring 3 has the function of selecting, i.e. unscrambling them, as described below.

On the other hand, orientation will be carried out in a particular area of the apparatus 1, along an angular section of the ring 3.

The preforms 5 are essentially U-shaped test tube-like containers, at whose upper end a collar of larger diameter than the body, usually threaded, is designed to receive a screw cap.

As mentioned above, the present apparatus may receive any object adapted to be unscrambled and oriented, i.e. having neck lips or collars larger than the body, so that their proper orientation can be defined using special gripper bars.

In more detail, the ring 3 is supported by a circular plate 6, which is also disposed inside the hopper 2 and connected by means of mechanical drives (gearwheels R1, chains, belts or pulleys) to appropriate motor units M1 underlying the hopper 2 and adapted to drive it to rotation thereby also rotating the ring 3.

According to a variant embodiment, the annular ring 3 only may be rotated by suitable known mechanical means, for example acting on its periphery, by providing it with appropriate sliding means, such as bearings or rollers for allowing rotation also relative to the plate 6, which is stationary.

In the above configuration, the plate 6 and the ring 3 are coplanar with the base 2b of the hopper 2.

As mentioned above, the ring 3 has rows of special preform housing pockets V along at least two circumferences C1 and C2; the pockets V of each row are aligned so that the preform can be disposed essentially tangent to the corresponding circumference C1 or C2.

While in this example two rows of pockets V are disposed on two circumferences C1 and C2, the requested protection obviously extends to solutions that use more than two rows, such as three, four or five rows: as a result, the exit lines, such as the guide bars 15 will be of such a number as to allow simultaneous ejection of the preforms from the overlying pockets.

The pockets V of two contiguous rows (on different circumferences C1 and C2) may be in any arrangement, i.e. they may either be adjacent, like in the illustrated example, or staggered.

To facilitate introduction of the preforms in the pockets V and selection thereof by the annular ring, the apparatus 1 is inclined to allow automatic withdrawal of preforms (see side view of FIG. 3).

Therefore, since the loading hopper 2 is inclined (by an angle A1) with respect to a support surface S of its cylindrical base 2b, a lower level Qi and an upper level Qs are defined, as well as corresponding zones Z1 and Z2 (lower and upper zones respectively) on which the preforms are received, i.e. loaded into the pockets V and selected, so that one preform 5 only is accommodated in each pocket V.

Such selection occurs either by spontaneous insertion of preforms 5 as the free pocket V passes through the zone Z1—due to rotation imparted thereto—or by using means such as one or more brushes 9 (in predetermined zones above the annular ring 3) which cause preforms 5 in excess or badly positioned in the corresponding pocket V to fall; this operation may conveniently be also performed using air jets suitably provided in the apparatus 1.

Once it is accommodated in its pocket V, the preform 5 takes an essentially horizontal position, i.e. in the plane of rotation of the annular ring 3, as shown in FIG. 5.

Such positioning occurs thanks to an annular support surface 8 (a sort of duplicate of the ring 3, without the pockets V); such surface 8 being located below the circular ring 3.

As particularly shown in FIGS. 2 and 5, the surface 8 does not extend all along the annular ring 3 (otherwise the preforms would rotate continuously and never exit from the machine) but only to a predetermined section, corresponding to the preform 5 exit point: once the preform 5 in the pocket V reaches such surface end, it falls by gravity onto the portion below the ring 3.

Now, the preform 5 may be conveniently oriented by underlying bars 15 located below the circular ring 3, near the end of the surface 8, so that it can be oriented and supported in an essentially upright position, as mentioned above and shown in the drawings.

In the illustrated embodiment, reference has been made to two rows of pockets V arranged along as many circumferences C1 and C2, hence three bars 15 will be provided to define two paths, one for each row of oriented preforms.

In other words, the bars 15 below the annular ring 3 (at the end of the support surface 8) cause the preforms 5 to be oriented to an essentially upright position, with the edge of each preform 5 lying on such bars 15 and the threaded portion above them.

Now, once the preforms 5 have been oriented by the bars 15, they can be kept in separate and independent rows or flow into a single feed row, as shown in these embodiments.

Obviously, when more rows of pockets V are provided on more concentric circumferences (C1, C2, . . . , Cn), a corresponding number of independent conveying rows may be formed using more guide bars 15.

The same applies to the partitions 7 within the hopper 2: when three circumferences are provided, two partitions of different lengths will be placed therein, i.e. a shorter partition for the inner circumference and a longer partition, to allow the inner portion to be filled before the outer portion.

The support surface 8 may be adjusted in position relative to its overlying ring 3, particularly when the preforms 5 have different sizes, i.e. occupy different volumes in their respective pockets V.

Such adjustment may be carried out using the supports 83 of the surface 8, which are threaded for engagement into a corresponding nut screw 81; for a better centered adjustment, such nut screw 81 may be combined with a gearwheel 83, with a chain (not shown) connecting the various gearwheels 83 under the hopper: by driving the chain, all the ring nuts 81 will be driven at a time for adjustment of the surface 8.

The above condition is shown in FIG. 2, which depicts a bottom view of the hopper 2.

Chain guiding means 88 are also provided for convenient actuation of the above drive.

Concerning the annular ring 3, it will be understood that it can be provided as a single large ring, or more conveniently composed of two or more circular arc sectors which form the illustrated circular ring when joined together; in this example, the ring 3 is composed of eight sectors designated as 3a.

As mentioned above regarding the surface 8, the ring 3 is interchangeable, i.e. easily removable from the corresponding support plate 6, to allow the use of different preform types.

In the embodiment with the ring 3 composed of multiple sectors 3a, one sector at a time may be replaced; with particular reference to FIGS. 10, 11 and 12, a plurality of knobs 70 are provided at the bottom of the plate 6, near its periphery, where they are engaged by respective pins 71 in corresponding holes; the end of the pin 71 coming out of the opposite part carries a cam 72: by adjusting the knobs 70, the cams 72 may be brought to two preferred open and closed positions A and C, as shown in the figures.

Reference A designates the open configuration, with the cam 72 disengaged from the corresponding pocket 3b in the sector 3a of the ring 3.

Reference C designates the closed configuration, with the cam 72 engaged with the corresponding pocket 3b in the sector 3a of the ring 3, to join the two elements (plate 6 and sector 3a).

Thus each sector 3a may be replaced with a corresponding sector whose pockets are appropriately sized to contain corresponding preforms.

Concerning the circular ring 3, for a more effective introduction of preforms 5 in both rows of pockets V and with particular reference to FIG. 1, the apparatus 1 is shown as having at least one partition 7 within the hopper 2, which extends essentially along an angular section from the preform exit to the loading zone (Z1) (where preforms are introduced in the free pockets of the ring 3); thus, the preforms 5 will be first introduced in the inner row (formed on the circumference C1); then, once the end of the partition has been reached, the outer row (circumference C2) will also open to the preforms 5 located in the zone Z1.

In this embodiment reference has been made to an apparatus 1 having an inclined hopper 2 and an inside plate and an annular ring parallel to the base 2b of the hopper; nevertheless, in an identical technical arrangement, a horizontal hopper may be used, i.e. with the base 2b acting as a bearing surface, and the plate and the ring 3 contained therein in inclined positions, without departure from the scope of the invention.

Also, when no automatic selection by inclination of the apparatus (in either manner described above) is used, selection may be nevertheless carried out by providing means for removing excess preforms, or feed barriers for enclosing the zone in which bulk loaded preforms are supported, as well as other means, such as blower elements for keeping the loading and selection zones Z1 and Z2 apart.

The bars 15 may have distance adjustment means for defining variable passages for preforms 5 of different sizes; in the embodiment as shown in FIG. 6, drive means, such as a handwheel 40 may be provided for driving mechanical members connected to the bars 15 to cause the desired displacement; in an effective arrangement, both channels created by the bars 15 can be adjusted by a single driving motion, the second row being displaced twice with respect to the first row (using appropriate gear ratios).

Furthermore, the handwheel 40 may operate not only on the corresponding shaft 42, but also on a parallel adjustment shaft 41 at the other end of the bars 15, for parallel displacement of the bars, particularly in case of bars of considerable length.

While reference has been made in this embodiment to an apparatus 1 having a ring 3 and a hopper 2 concentric with each other, they may be also disposed in staggered positions, by making the required structural changes.

The unscrambling and orienting apparatus 1 of the invention has been described heretofore in terms of features, functions and configuration; various conveyor and/or transport systems may be provided downstream from such apparatus 1, such as air conveyors, star wheels for transferring the preforms so unscrambled and oriented, or belt conveyors.

All the above systems may be combined with systems for controlling the oriented objects, such as the one designated by numeral 30 in FIG. 6 and succeeding figures.

Otherwise, deflector units 50 may be provided, if two or more rows have to be joined downstream of the apparatus 1.

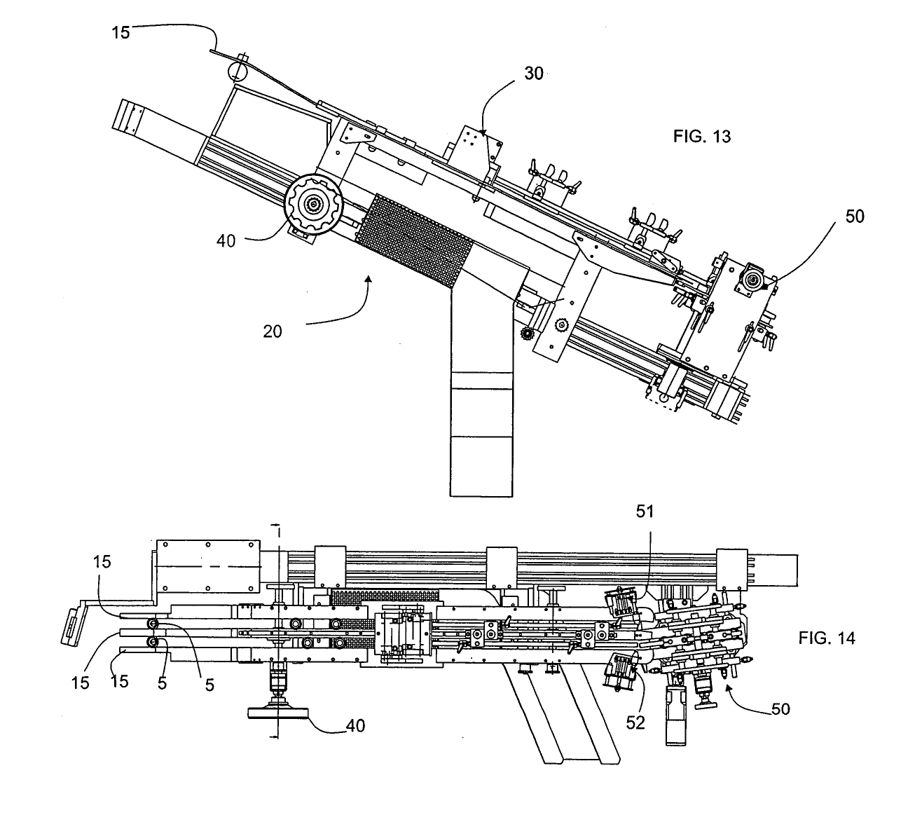

One type of conveyor 20 is described hereinafter, to be possibly combined with said apparatus 1, as shown in FIGS. 6, 7, 8, 9, 13 and 14.

The device 30 comprises two ejector units 31 and 32, which are designed to eject the preform 5 when it cannot pass through templates 35 due to its irregular shape; control means, such as preform presence sensing photocells, located at the templates 35, authorize ejection when a preform is stuck before a template 35.

The deflector unit 50 is shown in detail in FIGS. 7, 8 and 9, where a plate 53 may be noticed with a guide thereon for the passage of a single row 55 of preforms; therefore, such guide shall be oscillated first onto a row of preforms arriving from the upstream apparatus and then onto the other, preferably at regular intervals to avoid excessive buildups in the previous section.

Such oscillation is obtained by driving a first arm 60 beneath such plate 53, by means of a linear motor drive unit 56, such arm driving into reciprocating (and linear) motion a corresponding vertical pin 57 at whose end there is a sliding block 59 adapted to be engaged and slide in a corresponding guide 58: the reciprocating motion of this pin 57 will cause a corresponding oscillation of the plate 53, such plate pivoting about the fulcrum 54 and thus creating a moment of rotation, due to the arm generated between the drive and such fulcrum 54.

In order to stop the flow of preforms from a row not engaged with the guide of the deflector unit 50, pad means 51 and 52 (one for each row) are used, which operate alternately with the oscillation of the unit 50; thus, while a row is deflected by the device 50, the other row of preforms is stopped by its respective pad.

The operation of the deflector unit 50, the pads 51 and 52 and the ejector unit 30 may be controlled by a PLC, or dedicated software.

1-23. (canceled)

24. An apparatus (1) for unscrambling and orienting plastic preforms (5) or any object having neck lips or collars larger than the body, said preforms (5) or objects being introduced in bulk in a hopper (2) of said apparatus (1), said hopper (2) being formed of a base (2b) and vertical walls (2c) for holding the preforms (5), within said hopper (2):
a. an annular ring (3), rotating about an axis of rotation, has two or more rows of pockets (V) along corresponding concentric circumferences (C1, C2, . . . , Cn),
b. an annular object supporting surface (8), extending along an angular section under the circular ring (3) up to the predetermined object exit point, characterized in that comprises bars (15) near the end of the support surface (8), for receiving and orienting the objects from the overlying pockets (V); said bars (15) defining at least as many paths as the rows of pockets,
i.e. circumferences (C1, C2, . . . Cn) of the upper ring (3).

25. An apparatus (1) as claimed in claim 24, characterized in that it has at least one partition (7) within the hopper (2), which extends along an angular section from the exit of the preforms or objects in general to the loading zone (Z1).

26. An apparatus (1) as claimed in claim 24, characterized in that said ring (3) is supported by a central plate (6), which is also disposed inside the hopper (2).

27. An apparatus (1) as claimed in claim 26, characterized in that the plate (6) and the ring (3) are inclined with respect to the base (2b) of the hopper (2).

28. An apparatus (1) as claimed in 26, characterized in that the plate (6) and the ring (3) are coplanar with the base (2b) of the hopper (2).

29. An apparatus (1) as claimed in claim 24, characterized in that the pockets (V) are shaped in such a manner that each of them can accommodate one preform (5) or object.

30. An apparatus (1) as claimed in claim 24, characterized in that the annular support surface (8) may be adjusted in position relative to its overlying ring (3); said adjustment being carried out using the supports (83) of the surface (8), which are threaded for engagement into a corresponding nut screw (81); for a better centered adjustment, such nut screw (81) may be combined with a gearwheel (83), with a chain (not shown) connecting the various gearwheels (83) under the hopper: by driving the chain, all the ring nuts (81) will be driven at a time for adjustment of the surface (8).

31. An apparatus (1) as claimed in claim 24, characterized in that the annular ring (3) may be provided as a single ring, or more conveniently composed of two or more circular arc sectors (3a) which form the circular ring (3) when joined together.

32. An apparatus (1) as claimed in claim 24, characterized in that the ring (3) is interchangeable by special knobs (70) which are engaged by respective pins (71) in corresponding holes of the plate (6); the end of the pin (71) coming out of the opposite part carries a cam (72): by adjusting the knobs (70), the cams (72) can be brought to two preferred open and closed positions (A) and (C): in configuration (A) the cam (72) is disengaged from the corresponding pocket (3b) of the sector (3a) and/or of the ring (3); in configuration (C) the cam (72) is engaged with the corresponding pocket (3b) to join the two elements, i.e. the plate (6) and the sector (3a).

33. An apparatus (1) as claimed in claim 24, characterized in that the ring (3) and the hopper (2) may be concentric with each other or disposed in staggered positions.

34. An apparatus (1) as claimed in claim 26, characterized in that the plate (6) can rotate with the ring (3) or be fixed, with the ring (3) being free to rotate.

35. An apparatus (1) as claimed in claim 26, characterized in that mechanical drives, such as gearwheels (R1), chains, belts or pulleys, driven by a appropriate motor units (M1) underlying the hopper (2) are designed to drive said plate (6) and/or said ring (3) to rotation.

36. An apparatus (1) as claimed in claim 26, characterized in that the annular ring (3) may be rotated by suitable known mechanical means, acting on its periphery, by providing it with appropriate sliding means, such as bearings or rollers for allowing rotation also relative to the plate (6), when the latter is stationary.

37. An apparatus (1) as claimed in claim 24, characterized in that it is in an inclined position to allow automatic withdrawal of preforms (5) or objects to be unscrambled which will be disposed in the lower loading zone (Z1) whereas the ring (3) will select them in the upper zone (Z2).

38. An apparatus (1) as claimed in claim 26, characterized in that it is oriented with the hopper (2) in horizontal position, and the plate (6) and the ring (3) contained therein in inclined positions.

39. An apparatus (1) as claimed in claim 26, characterized in that it is oriented with the hopper (2), with the plate (6) and the ring (3) contained therein in horizontal positions, and selection is carried out by means for removing excess preforms or objects, or feed barriers for enclosing the support zone; as well as other means, such as blower elements for keeping the loading and selection zones Z1 and Z2 apart.

40. An apparatus (1) as claimed in claim 25, characterized in that, once the preforms (5) or objects have been oriented by the bars (15), they can be conveyed in separate and independent rows or flow into a single feed row.

41. An apparatus (1) as claimed in claim 25, characterized in that various conveyor and/or transport systems may be provided downstream from said apparatus (1), such as air conveyors, star wheels for transferring the objects so unscrambled and oriented, or belt conveyors.

42. An apparatus (1) as claimed in claim 25, characterized in that a conveyor device (20) is provided downstream from said apparatus (1), in which the rows are kept apart or joined together by one or two deflector units (50).

43. An apparatus (1) as claimed in claim 42, characterized in that said deflector unit (50) has a plate (53) with a guide thereon for the passage of a single row (55) of preforms (5) or objects; said plate (53) being oscillated between the two rows of the conveyor (20); in order to stop the flow of incoming preforms (5), pad means (51) and (52) operate alternately with the oscillation of the unit (50).

44. An apparatus (1) as claimed in claim 42, characterized in that said conveyor systems may comprise control devices (30) for confirming the proper profile of the preform; said devices (30) being composed of two ejector units (31) and (32), which are designed to eject the preform (5) when it cannot pass through templates (35) due to its irregular shape; control means, such as preform presence sensing photocells, located at the templates (35), authorize ejection when a preform is stuck before a template (35).

45. An apparatus (1) as claimed in claim 25, characterized in that the distance between the bars (15) is adjustable to define variable passages for preforms (5) of different sizes.
